(19) United States
(12) Patent Application Publication
(10) Pub. No.: US 2015/0290839 A1
(43) Pub. Date: Oct. 15, 2015

(54) BLOCK CARRIER WITH INTEGRATED CONTINUOUS MOULDING DEVICE FOR THERMOSOFTENING PLASTICS

(71) Applicant: Harald Zang, Kleinostheim (DE)

(72) Inventor: Harald Zang, Kleinostheim (DE)

(21) Appl. No.: 14/746,797

(22) Filed: Jun. 22, 2015

Related U.S. Application Data
(63) Continuation of application No. PCT/EP2013/003815, filed on Dec. 17, 2013.

(30) Foreign Application Priority Data
Dec. 21, 2012 (DE) 102012025259.5
Dec. 17, 2013 (EP) PCT/EP2013/003815

(51) Int. Cl. B29B 9/06; B29C 47/36; B29C 47/30; B29C 47/00; B29C 47/08

(52) U.S. Cl. CPC B29B 9/065; B29B 9/06; B29C 47/0066; B29C 47/0816; B29C 47/30; B29C 47/364; B29C 2793/009

(57) ABSTRACT

A block carrier with integrated strand die assembly for thermoplastic plastic material. The block carrier can have a block carrier housing, a melt pump assembly for delivering the thermoplastic material, and a start-up valve. The melt pump assembly and the start-up valve are integrated into the block carrier housing, providing a compact block carrier that is especially suited for use in environments with spatial constraints.

### CROSS REFERENCE TO RELATED APPLICATIONS

The present patent application is a Continuation Application that claims priority to and the benefit of co-pending International Patent Application No. PCT/EP2013/003815 filed Dec. 17, 2013, entitled “BLOCK CARRIER WITH INTEGRATED CONTINUOUS MOULDING DEVICE FOR THERMOSOFTENING PLASTICS”, which claims priority to DE Application No. 102012025259.5 filed Dec. 21, 2012. These references are hereby incorporated in their entirety.

### FIELD

The present embodiments generally relate to the field of pelletizing thermoplastic materials.

### BACKGROUND

The present embodiments of the invention generally relate to the field of pelletizing thermoplastic materials, and in particular to a block carrier with an integrated strand die assembly for forming strands from thermoplastic materials.

In order to produce pellets from thermoplastic material, in particular polymers such as polyethylene or polypropylene, underwater pelletizing units or strand pelletizing units are often used. These pelletizing units typically form strands from the thermoplastic material and the strands can then be reduced to granules by cutter heads or pelletizing devices. Pelletizing units are known to persons having ordinary skill in the art, such as the PRIMO® strand pelletizing system and the SPHERO® underwater pelletizing system from the firm AUTOMATIK PLASTICS MACHINERY.

In the prior art, it is proposed in the document to arrange a screen changer and a melt pump in a common housing. When a screen changer is provided within a common housing, the dwell time of the melt is reduced in comparison to an extrusion system with no screen changer or other filter. The path taken by the melt path is not impaired by additional adapters or connections to be provided between a separate screen changer and the melt pump, which can serve to increase the dwell time already necessary due to the other elements of the extrusion system.

Therefore, when a screen changer is provided within a common housing, the number of possible disturbance sources that could impair the flow of melt is reduced. For an extrusion system with no screen changer, however, the prior art however offers no proposal for how a reduction in impairments or in the dwell time of the melt can be achieved.

One object of the present invention is to reduce a dwell time of molten plastic material within an extruder system.

Another object of the present invention is to reduce impairments that could act to impair the flow of molten plastic material.

Yet another object of the present invention is to improve the pressure distribution of the molten plastic material at the apertures or nozzles of an extrusion die, in particular to make it more uniform in time and space.

In addition, it is an object of the present invention to specify a solution that is simple to manufacture.

These and other objects of the present present invention are attained by a block carrier with integrated strand die assembly for forming strands from thermoplastic material.

### BRIEF DESCRIPTION OF THE DRAWINGS

The detailed description will be better understood in conjunction with the accompanying drawings as follows:

FIG. 1 depicts a schematic representation of one embodiment of an extrusion system with downstream equipment and a downstream extrusion die.

FIG. 2 depicts a schematic of a block carrier sectioned longitudinally with an integrated strand die assembly according to an embodiment.

FIG. 3 depicts a schematic of a block carrier sectioned longitudinally with an integrated strand die assembly according to an embodiment.

FIG. 4 depicts a schematic top view of a block carrier with an integrated strand die assembly according to an embodiment.

FIG. 5 depicts a schematic top view of a block carrier with an integrated strand die assembly according to an embodiment.

FIG. 6 depicts a schematic of a block carrier sectioned longitudinally with an integrated strand die assembly according to an embodiment.

FIG. 7 shows a schematic of a block carrier downstream of an extruder with an integrated strand die assembly according to an embodiment.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The present invention is a block carrier with integrated strand die assembly for thermoplastic plastic material, wherein the block carrier has a block carrier housing, a melt pump assembly for delivering thermoplastic material, and a start-up valve. The melt pump assembly and the start-up valve can be integrated in the block carrier housing.

As a result of the integration of the strand die assembly, the melt pump assembly, and the start-up valve into a block carrier, pressure can build-up in the immediate vicinity of the strand die assembly. Intermediate flanges and long travel distances for the molten plastic material to reach the strand die assembly are eliminated, which reduces the dwell time of the molten plastic material within the system.

A substantially consistent operational pressure is achieved in this way. In addition, a desired pressure of molten plastic material at the strand die assembly can be reached more rapidly at startup. The time required at startup is reduced, and startup of the unit is facilitated.

The strand die assembly can comprise a perforated plate or nozzle plate, each having a plurality of nozzle orifices through which the molten thermoplastic material can be forced in order to form the strands of thermoplastic material.

In embodiments, the perforated or nozzle plate can be implemented as a single piece with the block carrier housing.

The block carrier housing can be implemented as multiple parts, which can further improve accessibility, ease of maintenance, and ease of manufacture. In embodiments, the block carrier housing can also be implemented as a single piece, which can further increase resistance to pressure.

In embodiments, the block carrier housing can be divided in a longitudinal direction into two or more block carrier housing sections. A plane that separates the block carrier housing sections can be substantially perpendicular to an axis of rotation of the melt pump assembly.

In embodiments, the block carrier housing can be divided in a transverse direction into two or more block carrier housing sections. A plane that separates the block carrier housing sections can be substantially parallel to an axis of rotation of the melt pump assembly and can intersect the melt pump assembly.

A multi-part implementation of the block carrier housing permits simpler manufacture and assembly. In addition, it is simpler to provide a nonlinear, curved or bent melt path along which the melt flows through the block carrier. This makes it possible to provide compact block carriers that are especially suited for use in environments with spatial constraints.

In embodiments, the melt pump assembly can be implemented as a gear pump.

In embodiments, the start-up valve can be located between the melt pump assembly and the strand forming assembly.

The block carrier can have a screen changer that is integrated into the block carrier housing.

The block carrier can have a heating means, such as a heating ring, or the like, which is or are integrated into the block carrier housing.

Furthermore, a connection flange for connecting an upstream extruder or an upstream filtration unit can be formed or located on the block carrier housing.

A pelletizing device for pelletizing thermoplastic material can have a block carrier.

In embodiments, the pelletizing device has a cutter head on which a plurality of blades are arranged so as to pass over the apertures or nozzle orifices and to cut, and thus pelletize, strands of thermoplastic material emerging from the apertures or nozzle orifices.

The pelletizing device can be configured to operate according to the underwater pelletizing method or according to the air-cooled die-face pelletizing method, both methods which are well known to persons having ordinary skill in the art.

The invention is described below using embodiments of the invention with reference to the drawings:

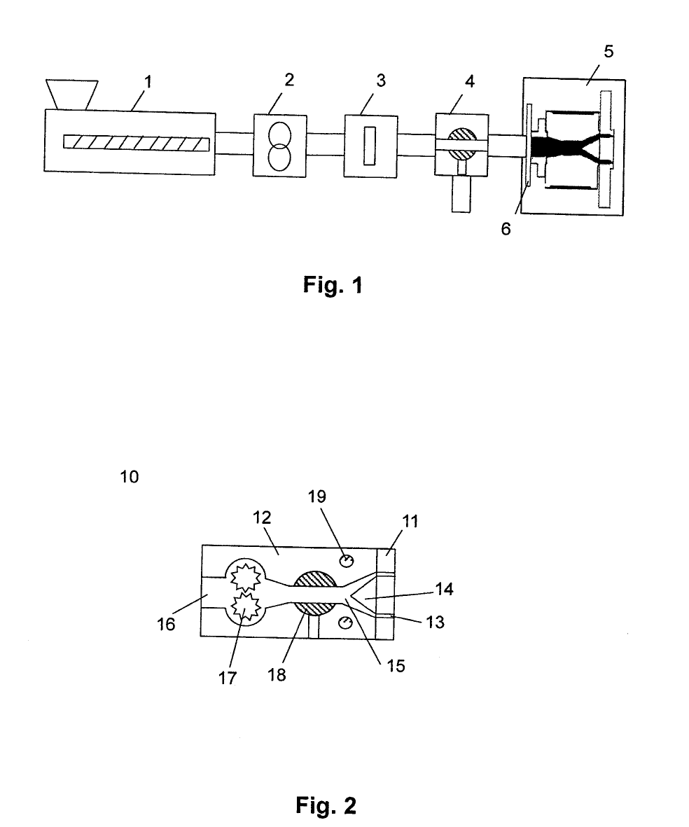

FIG. 1 depicts a schematic representation of one embodiment of an extrusion system with downstream equipment and a downstream extrusion die.

In typical extrusion systems, a strand die head or another extrusion die 5 can be continuously and uniformly supplied with a plastic melt. An extrusion system can have a screw extruder 1, a gear pump 2, and a start-up valve 4. A strand die or an extrusion die 5, such as a pelletizer equipped with a perforated plate, can be in communication with the start-up valve 4. In the event that especially stringent requirements are made for purity of the melt, or when the starting materials to be processed are contaminated, such as in the case of recycling, a melt filter 3 can also be used.

The function of the gear pump 2 is to uniformly discharge the molten plastic material extruded by the screw extruder 1 in opposition to the resistance of the downstream “pressure consumers” such as the extrusion die 5, the filter 3, the start-up device 4, as well as resistance from intermediate flanges, connecting lines, and any additional adapters 6 that may be inserted.

Even when the gear pump 2 delivers the molten plastic material with a substantially constant pressure, undesirable effects can arise on account of the variety of devices and connections through which the plastic material is to be pumped, creating unwanted pressure variations that occur at apertures or nozzles of the extrusion die 5. Moreover, the plastic material can have a relatively long dwell time before it is formed into strands by the apertures or nozzles of the extrusion die 5 in order to then be granulated.

FIG. 2 depicts a schematic of a block carrier sectioned longitudinally with an integrated strand die assembly according to an embodiment.

In this embodiment, a block carrier 10 with integrated strand die assembly for forming strands from thermoplastic material is shown. The block carrier 10 can be, for example, a strand die apparatus for a strand pelletizing system, or a component of a pelletizing device according to the underwater pelletizing method or the air-cooled die-face pelletizing method.

The strand die assembly can be implemented as a perforated plate or nozzle plate 11.

In this embodiment, the block carrier 10 has a block carrier housing 12 in which a melt inlet passage 16 is formed. The melt inlet passage 16 serves to receive molten thermoplastic material, hereinafter referred to as melt, from an upstream apparatus, such as an extruder, a reactor, a filter, or the like. One or more distribution chambers 15 can be formed in the block carrier 10 for the purpose of distributing the supplied melt and conducting it to a plurality of apertures or nozzles 13 that are formed in the perforated plate or nozzle plate 11.

The melt can be extruded through the apertures or nozzles 13 and formed into strands of the thermoplastic material. The strands can then be pelletized in a known way. The perforated plate or nozzle plate 11 can be implemented as a single piece in the block carrier housing 12, or can be fastened to the block carrier housing 12. A nose cone 14 can be attached at the upstream side of the perforated plate or nozzle plate 11, which can form one or more distribution chamber(s) 15, in conjunction with suitable walls of the block carrier housing 12,.

A melt pump assembly 17 can be integrated into the block housing 12 of the block carrier 10. The melt pump assembly 17 can be implemented as a gear pump. In addition, a start-up valve 18 can be integrated into the block housing 12 of the block carrier 10. The start-up valve 18 can be located downstream of the melt pump assembly 17 in the melt flow direction.

Alternatively, it is possible to arrange the melt pump assembly 17 downstream of the start-up valve 18 in the melt flow direction. Provision can additionally be made in this design for the melt pump assembly 17 or the start-up valve 18 to directly adjoin the distribution chamber(s) 15. A position at least partially inside the distribution chamber(s) 15 is likewise possible. In this way, it is possible to have better control of the melt pressure at the apertures or nozzles 13 of the perforated plate or nozzle plate 11 as well as to achieve an especially short design. The order of the individual elements in the melt flow direction is inherently adjustable and can be defined individually by persons having ordinary skill in the art in accordance with the installation, spatial, and application circumstances without departing from the teaching of the invention.

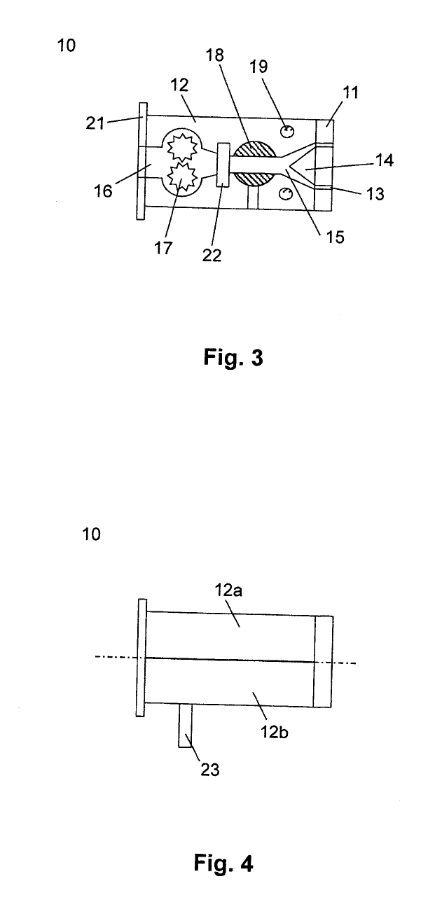

FIG. 3 depicts a schematic of a block carrier sectioned longitudinally with an integrated strand die assembly according to an embodiment.

In this embodiment, a screen changer 22 can additionally be integrated into the block carrier housing 12 of the block carrier 10. The screen changer can be advantageously located between the melt pump assembly 17 and the start-up valve 18.

In addition, a heating means 19, for example passages for a heat transfer fluid or an electric heating element, can be provided in the block carrier housing 12. It is likewise possible to provide an additional heating ring in the block carrier 10, wherein the melt pump assembly 17 can also be integrated into the heating ring. Many means of heating are well known within the art and can be integrated as required by a specific application.

In this embodiment, a connection flange 21 can be provided that is implemented as a single piece with the block carrier housing 12 or is alternatively fastened to the block carrier housing 12. The connection flange 21 can serve to attach the block carrier 10 to upstream devices, such as an extruder 1, a filter 3, or other devices as required by a specific application.

The block carrier housing 12 can be implemented in one piece.

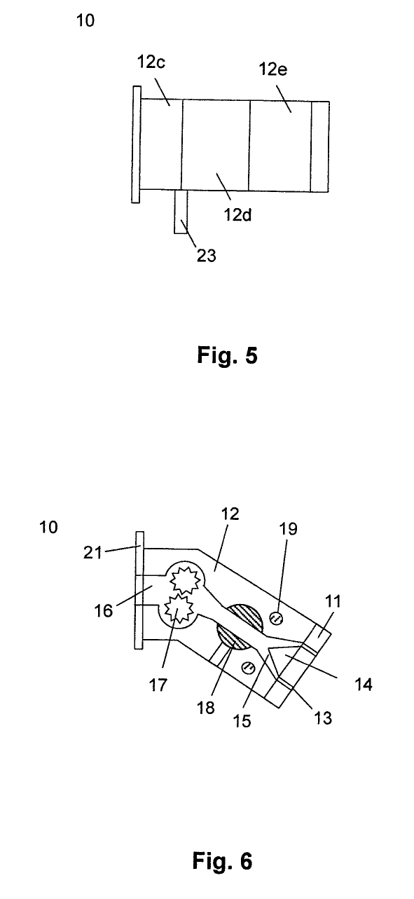

Alternatively, as shown in FIGS. 4 and 5, the block carrier housing 12 can also be implemented as multiple parts.

FIG. 4 depicts a schematic top view of a block carrier with an integrated strand die assembly according to an embodiment.

In this embodiment, the block carrier housing 12 can be implemented as multiple parts, shown here as two parts, with a first block carrier housing section 12a and a second block carrier housing section 12b.

In this embodiment, the block carrier housing 12 is divided in the longitudinal direction into the two block carrier housing sections 12a, 12b. The two block carrier housing sections 12a, 12b can adjoin one another in a plane that is substantially perpendicular to the axis of rotation of the melt pump. This permits simpler manufacture and ease of assembly of individual components of the block carrier 10. In particular, the individual chambers, passages, and walls that are formed in the block carrier housing 12 can be manufactured, operated, and maintained more easily, since the divided block carrier housing sections 12a, 12b permit easy access.

FIG. 5 depicts a schematic top view of a block carrier with an integrated strand die assembly according to an embodiment.

In this embodiment, the block carrier housing 12 can divided into two or more block carrier housing sections 12c, 12d, 12e in a plane transverse to the longitudinal axis or to the flow direction of the melt. The block carrier housing sections 12c, 12d, 12e can adjoin one another in a plane that is substantially parallel to an axis of rotation of a drive axle 23 of the melt pump assembly 17. Here, too, the division of the block carrier housing 12 into multiple block carrier housing sections 12c, 12d, 12e can permit simplified manufacture and assembly.

Since the melt is typically under very high pressure during operation of the block carrier 10, clamping means, such as clamping rings or the like, can be provided that contact one or more surfaces of the block carrier housing 12 and clamp and press the individual block carrier housing sections 12a, 12b, 12c, 12d, 12e against one another, absorbing the forces exerted by the pressurized melt in order to prevent the block carrier housing sections 12a, 12b, 12c, 12d, 12e from being forced apart.

FIG. 6 depicts a schematic of a block carrier sectioned longitudinally with an integrated strand die assembly according to an embodiment.

In this embodiment, the melt flow does not run straight from the inlet passage to the nozzles 13, but instead undergoes a bend. The integration of the melt pump assembly 17 and start-up valve 18 into the block carrier housing 12 here makes it possible for the melt to be directed along a desired, predetermined path within a small overall length. Thus the melt within the block carrier housing 12 can be directed along paths that are essentially straight section by section. In this way, it is possible to provide a solution that can be specifically tailored and designed for applications that are subject to requirements for small volumes and under spatial constraints.

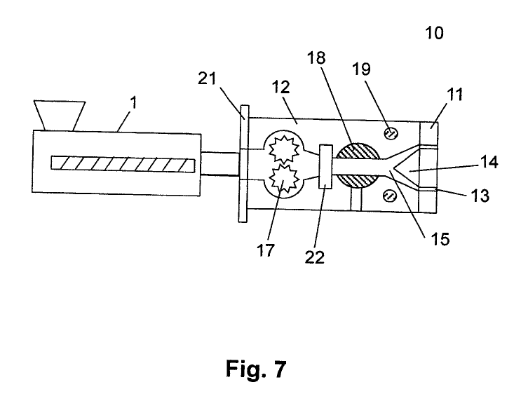

FIG. 7 shows a schematic of a block carrier downstream of an extruder with an integrated strand die assembly according to an embodiment.

In this embodiment, an extrusion system is followed by a block carrier 10 for forming strands from thermoplastic material. Owing to the integration of the melt pump assembly 17 and start-up valve 18 into the block carrier 10, the outlay of additional units that must be provided in the extrusion system is reduced significantly. Thus it can suffice to merely provide an extruder 1 in addition to the block carrier 10. In this way, a system is made possible that can be implemented with reduced space requirements.

FIGS. 2, 3, 6 and 7 each show embodiments with branching distribution chambers 15 and multiple nozzles 13 arranged next to or stacked on one another, for example along a circular path, which is to say preferably arranged in a two-dimensional structure as seen from a top view, in an appropriate nozzle plate 11. However, the invention is not restricted in this manner. The present invention can also be implemented with nozzles 13 arranged along a straight line in an appropriate nozzle plate 11, such as in a one-dimensional arrangement as seen from a top view. This can be useful for strand pelletizing devices or profile extrusion devices.

Although the invention was described in the foregoing using exemplary embodiments, the invention is not restricted to the examples cited. It should be understood that within the scope of the appended claims, the embodiments might be practiced other than as specifically described herein. For example, the strand die assembly can also be implemented in the form of a different extrusion die or molding tool that is designed to form one or more strands or profiles of thermoplastic material instead of the perforated or nozzle plate 11 cited by way of example in the foregoing.

As already explained above, the order of the appropriately arranged functional elements in the melt flow direction can also be varied with regard to their arrangement in the block carrier.

What is claimed is:

1. A block carrier with an integrated strand die assembly for thermoplastic plastic material, wherein the block carrier comprises a block carrier housing, and further wherein the block carrier housing comprises a melt pump assembly for delivering the thermoplastic material and a start-up valve.

2. The block carrier of claim 1, wherein the integrated strand die assembly comprises a perforated plate or a nozzle plate, wherein the perforated plate or the nozzle plate each comprise a plurality of nozzle orifices through which the thermoplastic plastic material can be forced in order to form strands of thermoplastic material.

3. The block carrier of claim 2, wherein:
a. the perforated plate is formed from a portion of the block carrier housing;
b. the perforated plate is affixed to the block carrier housing;
c. the nozzle plate is formed from a portion of the block carrier housing; or
d. the nozzle plate is affixed to the block carrier housing.

4. The block carrier of claim 1, wherein the block carrier housing is assembled from a plurality of block carrier housing portions.

5. The block carrier of claim 1, wherein the block carrier housing is divided into two or more block carrier housing sections.

6. The block carrier of claim 5, wherein the two or more block carrier housing sections adjoin in a plane, and further wherein the plane is substantially perpendicular to an axis of rotation of the melt pump assembly.

7. The block carrier of claim 5, wherein the two or more block carrier housing sections adjoin in a plane, and further wherein the plane is substantially parallel to an axis of rotation of the melt pump assembly.

8. The block carrier of claim 1, wherein the melt pump assembly comprises a gear pump.

9. The block carrier of claim 1, wherein the start-up valve is located between the melt pump assembly and the integrated strand die assembly.

10. The block carrier of claim 1, wherein the block carrier housing comprises a screen changer.

11. The block carrier of claim 1, wherein the block carrier housing comprises a means of heating.

12. The block carrier of claim 1, wherein the block carrier housing comprises a connection flange.

13. The block carrier of claim 12, wherein the connection flange is in communication with an upstream extruder or an upstream filtration unit.

14. A pelletizing device for pelletizing thermoplastic material, wherein the pelletizing device comprises a block carrier, wherein the block carrier comprises:
a. an integrated strand die assembly; and
b. a block carrier housing comprising:
(i) a melt pump assembly; and
(ii) a start-up valve.

15. The pelletizing device of claim 14, wherein at least one of:
a. the integrated strand die assembly comprises a perforated plate or a nozzle plate, wherein the perforated plate or the nozzle plate each comprise a plurality of nozzle orifices;
b. the block carrier housing is assembled from a plurality of block carrier housing portions;
c. the block carrier housing is assembled from a plurality of block carrier housing portions and:
(i) the perforated plate is formed from a portion of the block carrier housing;
(ii) the perforated plate is affixed to the block carrier housing;
(iii) the nozzle plate is formed from a portion of the block carrier housing; or
(iv) the nozzle plate is affixed to the block carrier housing;
d. the block carrier housing is divided into two or more block carrier housing sections;
e. the block carrier housing is divided into two or more block carrier housing sections and:
(i) the two or more block carrier housing sections adjoin in a plane, and further wherein the plane is substantially perpendicular to an axis of rotation of the melt pump assembly; or
(ii) the two or more block carrier housing sections adjoin in a plane, and further wherein the plane is substantially parallel to an axis of rotation of the melt pump assembly;
f. the melt pump assembly comprises a gear pump;
g. the start-up valve is located between the melt pump assembly and the integrated strand die assembly;
h. the block carrier housing comprises a means of heating;
i. the block carrier housing comprises a connection flange;
j. the block carrier housing comprises a connection flange, wherein the connection flange is in communication with an upstream extruder or an upstream filtration unit; or
k. the connection flange is in communication with an upstream extruder or an upstream filtration unit.

16. The pelletizing device of claim 14, comprising a cutter head, wherein the cutter head comprises a plurality of blades configured to cut strands of thermoplastic material emerging from the nozzle orifices.

17. The pelletizing device of claim 14, wherein the pelletizing device is configured to operate according to an underwater pelletizing method or according to an air-cooled die-face pelletizing method.
